(19) United States
(12) Patent Application Publication
(10) Pub. No.: US 2020/0045931 A1
(43) Pub. Date: Feb. 13, 2020

(54) PORTABLE ELECTRIC FENCE SYSTEM

(71) Applicant: Jaime John MacCaig-Ross, Chilliwack (CA)

(72) Inventor: Jaime John MacCaig-Ross, Chilliwack (CA)

(21) Appl. No.: 16/100,139

(22) Filed: Aug. 9, 2018

(51) Int. Cl. A01K 3/00; A01K 1/00

(52) U.S. Cl. CPC A01K 3/005; A01K 1/0035

(57) ABSTRACT

A portable electric fence system including a fence assembly having at least one multi-post, at least one step-in post, a reel and an electric gate. The fence assembly comprises in a series, the at least one step-in post with the at least one multi-post being positioned at corner-portions of a temporary electrified perimeter fenced area. The bottom-end of the at least one multi-post and the at least one step-in post are configured to be inserted into a ground surface. Poly-wire is strung through and supported by a series of reels. The reel is battery powered and configured to reel in the poly-wire. The at least one multi-post, the at least one step-in post, the reel, and the electric gate are configured to be used in combination to define a temporary electrified perimeter fenced area for retaining livestock.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of fences of existing art and more specifically relates to electric fences.

### RELATED ART

An important aspect of livestock farming is the ability to provide high quality feed to the animals at all times of the year at the lowest possible price. Two distinct methods are typically used: year-round confinement feeding, and pasturing. Generally, two types of feed are used to maintain the animals in good condition. In the winter, the animals are usually fed stored forage that has been machine harvested during the summer and fall months. Termed silage, this is generally supplemented with grains and vitamins. This is an expensive method of feeding the animals, which has the unwanted result of increasing the farmer's production cost. The second type of feed is associated with the pasturing method. Animals are turned out to pasture during the spring, summer and fall months when pasture plants are creating enough quality forage for the animals to subsist. This is the lowest-cost method of feeding animals, but it cannot be maintained year-round in most areas of the country. Permanent pastures also become run-down which is undesirable if not effectively managed. Fencing can be very expensive and not suitable for temporary use.

Good grazing produces food and fiber while keeping the soil covered with vegetation, improving water storage, preventing erosion and nutrient migration, and maintaining water quality. These are all vital ecosystem services. Good grazing management is also important to allowing the seasonal uptake of carbon to be as great as it can be, and to ensuring that the carbon in the soil doesn't oxidize and head back into the atmosphere at a greater rate. Done poorly, grazing can have negative effects. Grazing too early in the season reduces the leaf surface area that's so important for the seasonal uptake of carbon into the soil. Practices that encourage shorter rooted vegetation over longer rooted plants also reduce seasonal uptake. Finally, grazing so that the soil bare through the winter can turn grasslands into carbon sources. A suitable solution is desired.

U.S. Pat. No. 3,972,307 to Jorge Marseillan relates to a moveable fence to control cattle pasturage. The described moveable fence to control cattle pasturage includes a plurality of contiguous fence sections with transverse displacement means contacting the ground, means connecting contiguous sections, means forming an opening in each section to permit passage of the head of an animal therethrough and pushing means for allowing fence displacement.

### SUMMARY OF THE INVENTION

In view of the foregoing disadvantages inherent in the known fence art, the present disclosure provides a novel portable electric fence system. The general purpose of the present disclosure, which will be described subsequently in greater detail, is to provide a portable fencing solution for retaining cattle or other livestock.

A portable electric fence system is disclosed herein. The portable electric fence system includes a fence assembly including a fence assembly including at least one multi-post, at least one step-in post, a reel and an electric gate. The fence assembly comprises in a series, the at least one step-in post with the at least one multi-post being positioned at corner-portions of a temporary electrified perimeter fenced area. The bottom-end of the at least one multi-post and the at least one step-in post are configured to be inserted into a ground surface. Poly-wire is strung through and supported by a series of reels. The reel is battery powered and configured to reel in the poly-wire. The at least one multi-post, the at least one step-in post, the reel, and the electric gate are configured to be used in combination to define a temporary electrified perimeter fenced area for retaining livestock.

A kit is also disclosed herein including a set of instructions, at least one multi-post, at least one step-in post, a reel, and an electric gate.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a portable electric fence system, constructed and operative according to the teachings of the present disclosure.

FIG. 1 is a perspective view of the portable electric fence system during an ‘in-use’ condition, according to an embodiment of the disclosure.

FIG. 2 is a perspective view of the portable electric fence system of FIG. 1, according to an embodiment of the present disclosure.

FIG. 3 is a perspective view of the portable electric fence system of FIG. 1, according to an embodiment of the present disclosure.

FIG. 4 is a perspective view of the portable electric fence system of FIG. 1, according to an embodiment of the present disclosure.

FIG. 5 is a perspective view of the portable electric fence system of FIG. 1, according to an embodiment of the present disclosure.

FIG. 6A is a perspective view of the portable electric fence system of FIG. 1, according to an embodiment of the present disclosure.

FIG. 6B is a perspective view of the portable electric fence system of FIG. 1, according to an embodiment of the present disclosure.

FIG. 7 is a perspective view of the portable electric fence system of FIG. 1, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a fence and more particularly to a portable fence as used to improve the use of temporary fencing to retain animals and enable users to move the animals as necessary to ‘sync’ with grass cycles.

Generally, portable electric fence system provides a portable and temporary electric fence solution which effectively eliminates the need to install costly, time consuming permanent fences to fence in cattle or other livestock. The portable electric fence system includes a series of posts and means to provide voltage to a poly wire fence. The poly wire is configured to be woven through a series of reels located along a length of the posts. Approximately 70 feet of poly wire may be stored within the housing. Certain reels on the end posts may be used to string the poly wire at an angle in connection with another subsequent post. Other reels may include quick release buttons. The reels can be screwed in or quick-release with a set number of lines (fingers) based on animals contained within the fence. The fence may be customized using gates and step-ins. A weight or other suitable means may be provided on certain reels to keep the poly wire in tension during use. A power source is externally provided by a user.

A housing is included for storing the battery configured to provide voltage to the poly wire fence. In a preferred embodiment, the housing further includes a yellow LED indicator light, a free wheel switch, auto reel over ride switch, a power reel, and a retracting pin (brass, plastic or other suitable material). The housing is waterproof and may be in communication with an insulated alligator clip configured to provide 10,000 volts. The power source is strategically placed for semi-permanent installations. In certain embodiments, the housing may further include a media or music playing device for playing relaxing music for the livestock contained within the fence. The posts may be spaced approximately 16 feet from one another with the poly wire being in tension. The posts are connected via a jumper wire. An electrical current passes through the series of posts via the wire provided. The voltage may be adjustable to accommodate various sizes and genders of animals contained within the fence.

The end posts further comprise a Bowflex®-style brace storage hole, a Bowflex® semi-flexible bar, a large step and a spike having a spike stop. The spikes may act as ground line for the fence. In a preferred embodiment, the spikes are 8″ hardened steel. The Bowflex® semi-flexible bar is configured to allow the fence to flex and provide some slack in the fence wiring. The large step may be approximately 4″-5″ allowing a user to drive the post into a ground surface. The at least one multi-post comprises an anti-lift stiletto and a storage compartment. The anti-lift ‘stiletto’ used for a valley bottom when setting up a fence. Pressure of lines may also be used to keep the fence posts in a vertical position. The posts may be inserted into the ground at various heights for uneven terrain and valleys. Corner brace storage compartments may further be included. No drag step-ins may be used for controlling line reel-in. The device includes a 3-in-1-reel system. The no drag step-ins eliminate walking the fence to reel in a line, and oscillation of a line is eliminated.

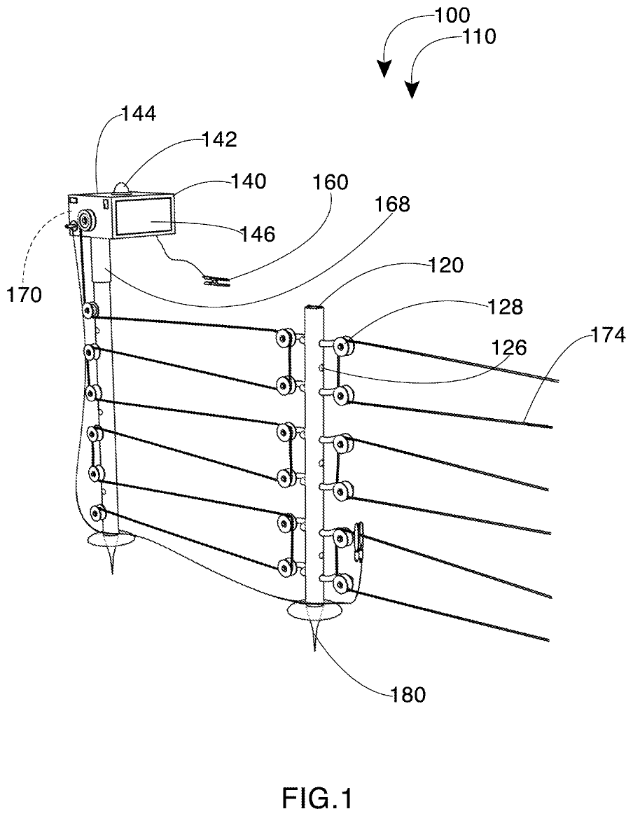

Referring now more specifically to the drawings by numerals of reference, there is shown in FIGS. 1-5, various views of a portable electric fence system 100. FIG. 1 shows a portable electric fence system 100 during an ‘in-use’ condition 150, according to an embodiment of the present disclosure. Here, the portable electric fence system 100 may be beneficial for use by a user to define a portable electrified perimeter fenced area for retaining livestock. As illustrated, the portable electric fence system 100 may include a fence assembly 110 including at least one multi-post 124, at least one step-in post 120, a reel 136 and an electric gate. The fence assembly 110 comprises in a series, the at least one step-in post 120 with the at least one multi-post 124 being positioned at corner-portions of a temporary electrified perimeter fenced area. The bottom-end 130 of the at least one multi-post 124 and the at least one step-in post 120 are configured to be inserted into a ground surface. Poly-wire 174 is strung through and supported by a series of reels 128. The reel 136 is battery powered and configured to reel in the poly-wire. The at least one multi-post 124, the at least one step-in post 120, the reel 136, and the electric gate are configured to be used in combination to define a temporary electrified perimeter fenced area for retaining livestock.

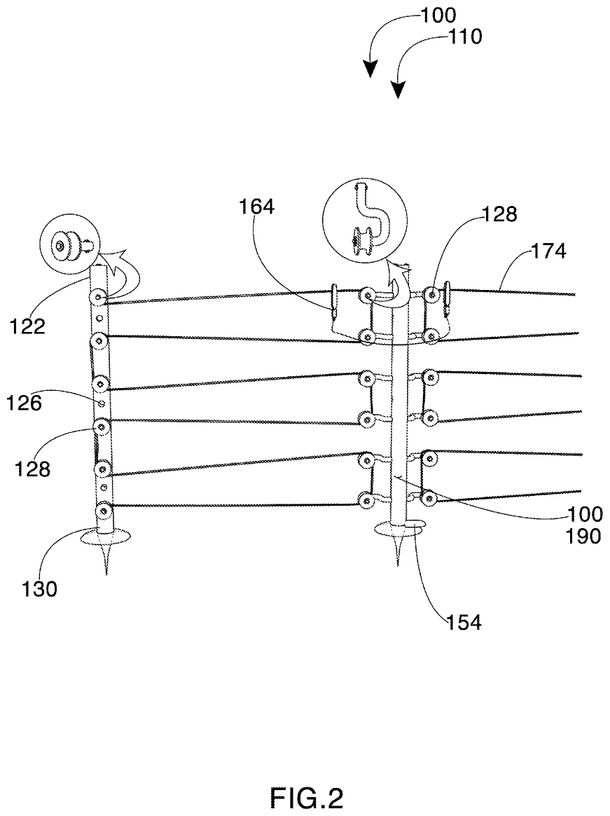

Referring now to FIG. 2 showing a view of the portable electric fence system 100 comprising the fence assembly 110 including at least one multi-post 124, at least one step-in post 120, a reel 136 and an electric gate. The fence assembly 110 further includes housing 140, a voltage transmitting member 160, a jumper-wire 164, an insertion-member 168, a battery 170, and poly-wire 174. The housing 140 is configured to release the poly-wire 174. The voltage transmitting member 160 is an insulated alligator clip which extends from the housing 140 and transmits voltage to the poly-wire 174 and at least two posts 120. The voltage is adjustable to accommodate various genders and sizes of animals. As an example, the more stubborn breed and sex may influence the voltage to be higher to physically stop animals and restrain the animals within the temporary electrified perimeter fenced area. The housing 140 further includes a light indicator 142 positioned on a top-portion 144. In a preferred embodiment, the fence assembly 110 further includes music playing capabilities. The music may be used for calming the cattle or other animals fenced within. The housing 140 is waterproof and further comprises a display 146.

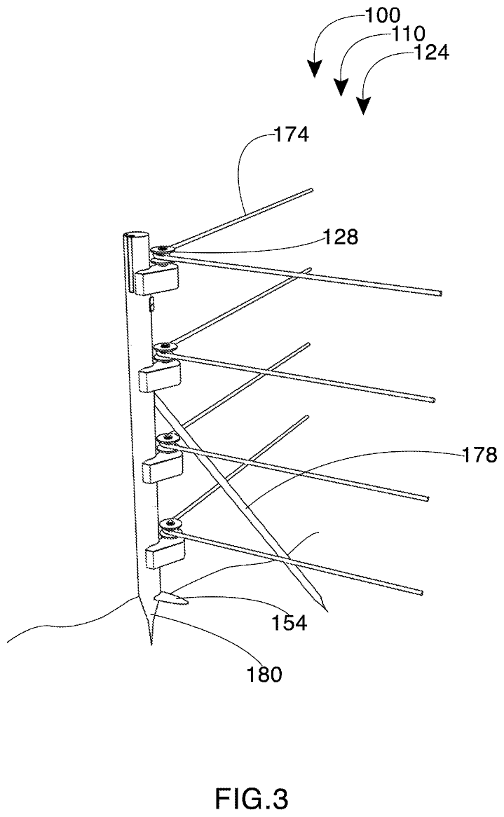

Referring now to FIG. 3 showing a view of the portable electric fence system 100 of FIG. 1, according to an embodiment of the present disclosure comprising at least one multi-post 124 and at least one step-in post 120. The portable electric fence system 100 may be used to create temporary training corrals having a series of sections using the posts 120, at least one multi-post (corner posts) 124, gates, paddocks, and walkways. The at least one multi-post 124 is an end-post and is preferably positioned on corner portions of a fenced area. The paddock size may be in relation to herd size and grass cycle. The at least one multi-post 124 and the at least one step-in post 120 comprise apertures 126 positioned along the length for receiving one of the series of reels 128 at various heights. The series of reels 128 are removeable and height-adjustable. The series of reels 128 positioned along the end-post 124 allow the poly-wire 174 to be strung at an angle between 0 and 160 degrees. The end-post 124 further includes a step 154 for inserting the end-post 124 into the ground surface. The at least one multi-post 124 and the at least one step-in post 120 further include a post-brace. The at least one multi-post 124 and the at least one step-in post 120 further include stakes 180 configured at the bottom-end 130. The at least one multi-post 124 further include a ground wire retention member(s) 190. The portable electric fence system 100 significantly reduces a cost of installing a fence by providing a temporary, effective fencing solution.

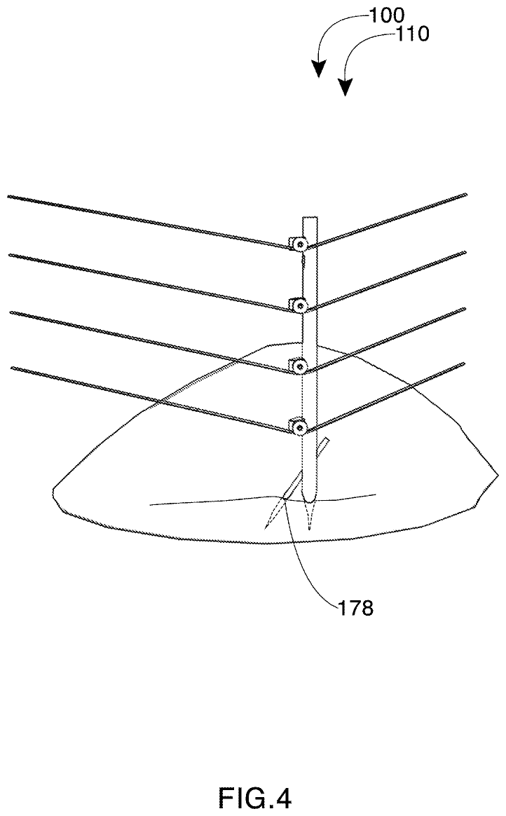

Referring now to FIG. 4 showing a view of the portable electric fence system 100 of FIG. 1, according to an embodiment of the present disclosure. The fence assembly 110 further includes a no drag step-in system having step-ins which may be used to eliminate the need to walk an entire perimeter of the fence to reel the poly wire 174. The fence assembly 110 further includes at least one electric gate to be used in combination with the at least one multi-post 124 and the at least one step-in post 120. The no drag step-in system may be used for elevation and direction changes. Screws may be provided for adjusting a height. A quick release (or permanent screw) is further provided. The portable electric fence system 100 is configured to reduce carbon sources and provide a portable grazing fence for cattle in sync with grass cycles.

According to one embodiment, the portable electric fence system 100 may be arranged as a kit. In particular, the portable electric fence system 100 may further include a set of instructions, at least one multi-post 124; at least one step-in post 120; a reel 136; and an electric gate. The instructions may detail functional relationships in relation to the structure of the portable electric fence system 100 such that the portable electric fence system 100 can be used, maintained, or the like, in a preferred manner.

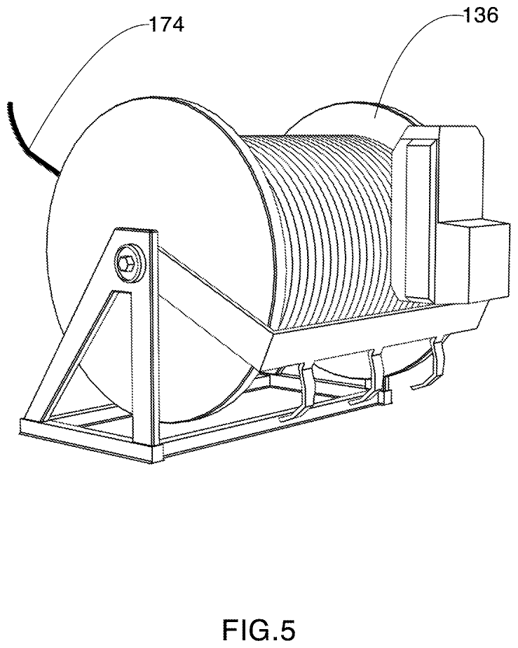

Referring now to FIG. 5 showing a view of a mega reel 136 of the present invention for reeling the poly-wire 174. The reel 136 may be used to reel in a line faster than by hand. The reel 136 may include free wheel, a lock, and a speed throttle.

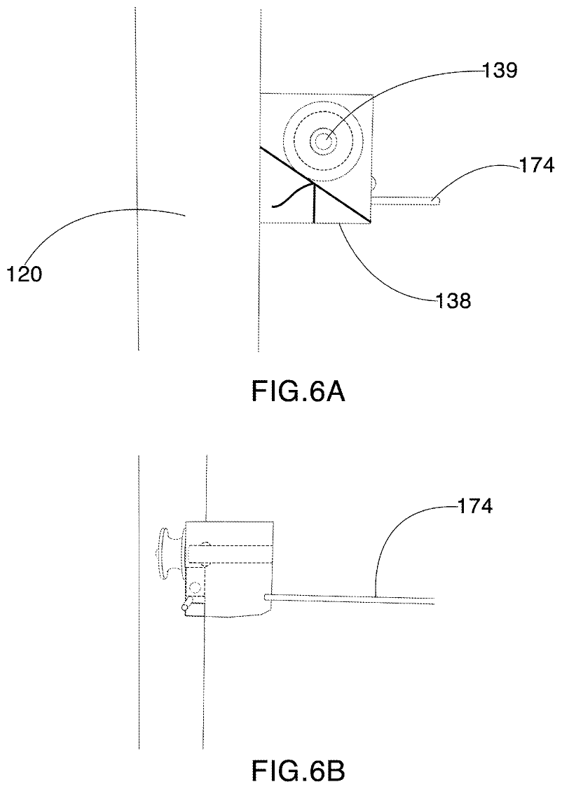

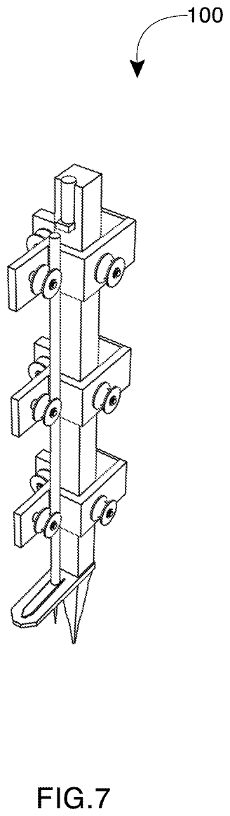

A poly wire end pinch is shown in FIGS. 6A and 6B having a spring release wedge lock 138 including a quick release button 139 for saving time and energy when setting up a fenced area. The advantage of the spring release wedge lock 138 is that it keeps a dead end of the poly wire 174 straight rather than a tied bow which may touch everything as it is being wound up. One of the spring release wedge locks 138 may positioned at the bottom of every post 120. FIG. 7 shows a view of at least one multi-post 124. The multi-post 124 of FIG. 7 may further eliminate the requirement for jumper leads at 3-way and/or 4-way intersections.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A portable electric fence system comprising:
a fence assembly including;
at least one multi-post;
at least one step-in post;
a reel;
an electric gate;
wherein said fence assembly comprises in a series, said at least one step-in post with said at least one multi-post being positioned at corner-portions of a temporary electrified perimeter fenced area;
wherein said bottom-end of said at least one multi-post and said at least one step-in post are configured to be inserted into a ground surface;
wherein poly-wire is strung through and supported by a series of reels;
wherein said reel is battery powered and configured to reel in said poly-wire; and
wherein said at least one multi-post, said at least one step-in post, said reel, and said electric gate are configured to be used in combination to define a temporary electrified perimeter fenced area for retaining livestock.

2. The portable electric fence system of claim 1, wherein said fence assembly further includes a housing with a voltage transmitting member, a jumper-wire, an insertion-member, and a battery.

3. The portable electric fence system of claim 2, wherein said voltage transmitting member is an insulated alligator clip which extends from said housing and transmits voltage to said at least two posts.

4. The portable electric fence system of claim 1, wherein said housing further includes a light indicator.

5. The portable electric fence system of claim 1, wherein said fence assembly further includes music playing capabilities.

6. The portable electric fence system of claim 1, wherein said housing further comprises a display.

7. The portable electric fence system of claim 1, wherein said at least one multi-post further include a ground wire retention member(s).

8. The portable electric fence system of claim 1, wherein said at least one multi-post and said at least one step-in post further include stakes.

9. The portable electric fence system of claim 1, wherein said at least one multi-post and said at least one step-in post comprise apertures positioned along said length for receiving one of said series of reels at various heights.

10. The portable electric fence system of claim 9, wherein said series of reels are removeable and height-adjustable.

11. The portable electric fence system of claim 1, wherein said at least one multi-post is an end-post.

12. The portable electric fence system of claim 11, wherein said end-post further includes a step for inserting said end-post into said ground surface.

13. The portable electric fence system of claim 11, wherein said at least one multi-post further include a post-brace.

14. The portable electric fence system of claim 11, wherein said series of reels positioned along said end-post allow said poly-wire to be strung at an angle.

15. The portable electric fence system of claim 1, wherein said at least one multi-post comprises an anti-lift stiletto.

16. The portable electric fence system of claim 1, wherein said electric gate is 16′.

17. The portable electric fence system of claim 1, wherein a power source is externally provided.

18. The portable electric fence system of claim 1, wherein said portable electric fence system is configured to reduce carbon sources and provide a portable grazing fence for cattle in sync with grass cycles.

19. A portable electric fence system, the portable electric fence system comprising:
a fence assembly including;
at least two posts having;
an open top-end;
a series of reels positioned along a length; and
a bottom-end;
a housing;
a voltage transmitting member;
a jumper-wire;
an insertion-member;
a battery; and
poly-wire;
wherein said fence assembly comprises in a series, said at least two posts and said housing, said top-end configured to receive said insertion-member of said housing and support said housing;
wherein said bottom-end of said at least two posts are configured to be inserted into a ground surface;
wherein said housing is configured to release said poly-wire, said poly-wire is strung through and supported by said series of reels;
wherein said voltage transmitting member is an insulated alligator clip which extends from said housing and transmits voltage to said at least two posts;
wherein said voltage is adjustable;
wherein said at least two posts are configured to be used to define a temporary electrified perimeter fenced area for retaining livestock;
wherein said housing further includes a light indicator;
wherein said fence assembly further includes music playing capabilities;
wherein said housing further comprises a display;
wherein said housing is waterproof;
wherein said poly-wire is poly wire;
wherein said at least two posts comprise apertures positioned along said length for receiving one of said series of reels at various heights;
wherein said series of reels are removeable and height-adjustable;
wherein said at least two posts includes an end-post;
wherein said end-post further includes a step for inserting said end-post into said ground surface;
wherein said at least two posts further includes a post-brace;
wherein said series of reels positioned along said end-post allow said poly-wire to be strung at an angle;
wherein said at least two posts further include stakes;
wherein said at least two posts further include a ground wire retention member(s);
wherein said fence assembly further includes step-ins; and
wherein said fence assembly further includes at least one electric gate to be used in combination with said at least two posts and said housing.

20. The portable electric fence system of claim 19, further comprising:
a set of instructions;
at least one multi-post;
at least one step-in post;
a reel;
an electric gate; and
wherein said portable electric fence system is arranged as a kit.
